(19) United States
(12) Patent Application Publication
(10) Pub. No.: US 2004/0188386 A1
(43) Pub. Date: Sep. 30, 2004

(54) Substrate treating method and apparatus

(75) Inventor: Takashi Izuta, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg. Co., Ltd.

(21) Appl. No.: 10/806,844

(22) Filed: Mar. 22, 2004

(30) Foreign Application Priority Data
Mar. 27, 2003 (JP) 2003-087683

(51) Int. Cl. B08B 3/00

(52) U.S. Cl. 216/83

(57) ABSTRACT

Before a lifter holding a group of substrates is immersed in a heated treating solution, the lifter is immersed in the phosphoric acid solution to preheat the lifter to substantially the same temperature as the phosphoric acid solution. The temperature of the phosphoric acid solution is prevented from lowering under the influence of the lifter when the group of substrates held by this lifter is immersed in the phosphoric acid solution. Consequently, variations in treatment occurring among the substrates treated collectively are suppressed.

### BACKGROUND OF THE INVENTION

(1) Field of the Invention

This invention relates to a substrate treating method and apparatus for performing a predetermined treatment of semiconductor wafers, glass substrates for liquid crystal displays, glass substrates for photomasks and substrates for optical disks (hereinafter called simply “substrates”). More particularly, the invention relates to a substrate treating method and apparatus for performing a predetermined treatment of substrates by immersing a plurality of substrates collectively in a heated treating solution.

(2) Description of the Related Art

A substrate treating apparatus of this type is known from Japanese Unexamined Patent Publication No. 11-145107 (1999), for example, which performs a selective etching treatment of silicon nitride film formed on surfaces of substrates such as semiconductor wafers. This apparatus includes a treating tank for storing a heated phosphoric acid solution, and a vertically movable substrate holding mechanism called a lifter for holding a plurality of (e.g. 50) substrates in vertical posture. The substrate holding mechanism holding the substrates is lowered into the treating tank to immerse the substrates in the phosphoric acid solution for batch treatment.

The conventional apparatus having such a construction has the following drawback.

Since the rate of etching the silicon nitride film is influenced by the concentration and temperature of the phosphoric acid solution, the concentration and temperature of the solution are strictly controlled. However, the substrates treated as a batch are subject to an inconvenience of an etching amount varying from substrate to substrate.

### SUMMARY OF THE INVENTION

This invention has been made having regard to the state of the art noted above, and its object is to provide a substrate treating method and apparatus capable of suppressing variations in treatment occurring among substrates treated collectively.

To fulfill the above object, Inventor has made intensive research and attained the following findings.

As shown in FIG. 1, Inventor has placed 50 substrates (semiconductor wafers) W on a lifter 20 and immersed them in a phosphoric acid solution stored in a treating tank 22 and heated to 150° C. to observe the rates of etching silicon nitride film formed on surfaces of the wafers W. The lifter 20 has a plurality of elongate holding rods 20a for holding a group of wafers W in vertical posture to be treated collectively, and a back plate 20b supporting the holding rods 20a in cantilever fashion. Both holding rods 20a and back plate 20b are formed of quartz. The etching rates were checked in respect of the wafer W nearest to the back plate 20b (slot No. 1), the wafer W positioned in the middle (slot No. 25) and the wafer W remotest from the back plate 20b (slot No. 50). Such checking was carried out for each of three lots (first lot to third lot) which are units of wafers W treated in batches. The results are shown in FIG. 1. The numerals in the table of FIG. 1 represent etching rates (Å/min).

As seen from FIG. 1, the first lot shows a maximum difference of 1.7 Å/min. in etching rate between the substrates. The second lot shows a difference of 1.51 Å/min. in etching rate between the substrates. The third lot shows a difference of 1.77 Å/min. in etching rate between the substrates.

Upon further examination of the results shown in FIG. 1, it will be seen that the etching rate increases the farther away from the back plate 20b. In other words, the etching rate is the lower for the substrates lying closer to the back plate 20b. Inventor considers that the cause is a local temperature decrease of the phosphoric acid solution resulting from the large heat capacity of the back plate 20b. The heat capacity of the back plate 20b is about one liter, which is far larger than that of the elongate holding rods 20a holding the wafers W. Actual measurements taken when the lifter 20 was immersed into the 150° C. phosphoric acid solution showed a temperature fall of about 1° C. A greater temperature fall is thought to occur in the vicinity of the back plate 20b. It is thus believed that the phosphoric acid solution undergoes the greater temperature fall in the portions closer to the back plate 20b, which causes the lowering of the etching rate.

Based on the above findings, this invention provides a substrate treating method for performing a predetermined treatment of a plurality of substrates as held by a substrate holding device and immersed in a heated treating solution, wherein the substrate holding device is heated before immersing the substrate holding device holding the substrates in the heated treating solution.

In the method according to this invention, the substrate holding device is heated before immersing the substrate holding device holding the substrates in the heated treating solution. The temperature of the treating solution is prevented from lowering under the influence of the substrate holding device when the group of substrates held by this substrate holding device is immersed in the treating solution. Consequently, variations in treatment occurring among the substrates treated collectively are suppressed.

The above method is not limited to any particular way of heating the substrate holding device. For example, the substrate holding device is heated by being placed in a heated atmosphere or heated liquid, before immersing the substrate holding device holding the substrates in the heated treating solution. The substrate holding device may be heated by being placed in the heated treating solution without holding the substrates, before immersing the substrate holding device holding the substrates in the heated treating solution. Then, the substrate holding device is heated to substantially the same temperature as the treating solution. This provides the advantage of minimizing the influence imparted on the treating solution.

Further, the substrate holding device may be heated by a heating device provided therefor, before immersing the substrate holding device holding the substrates in the heated treating solution.

A substrate treating apparatus, according to this invention, for performing a predetermined treatment of a plurality of substrates as immersed in a heated treating solution, comprises: a treating tank for storing the heated treating solution; a substrate transport mechanism for transporting the plurality of substrates; a substrate holding device for holding the substrates received from the substrate transport mechanism and immersing the substrates in the heated the treating solution stored in the treating tank; and a control part for keeping the substrate holding device on standby in the heated treating solution stored in the treating tank, before the substrate holding device receives the substrates from the substrate transport mechanism.

With the apparatus according to the invention, the substrate holding device is kept on standby in the heated treating solution stored in the treating tank, before the substrate holding device receives the substrates from the substrate transport mechanism. During the standby, the substrate holding device is heated to substantially the same temperature as the treating solution. Subsequently, the substrate holding device is raised from the treating tank, and receives the substrates from the substrate transport mechanism. The substrate holding device having received the substrates is promptly lowered into the treating solution in the treating tank. Since the substrate holding device is preheated in the treating solution, the temperature fall of the treating solution due to the immersion of the substrate holding device is suppressed to check variations in treatment occurring among the substrates.

A substrate treating apparatus, according to another aspect of this invention, for performing a predetermined treatment of a plurality of substrates as immersed in a heated treating solution, comprises: a treating tank for storing the heated treating solution; a substrate transport mechanism for transporting the plurality of substrates; and a substrate holding device for holding the substrates received from the substrate transport mechanism and immersing the substrates in the heated the treating solution stored in the treating tank; wherein the substrate holding device includes a plurality of holding rods for holding the plurality of substrates in vertical posture, and a back plate supporting the holding rods in cantilever fashion, the back plate having a heating device.

With this apparatus, the substrate holding device includes a back plate having a relatively large heat capacity, and this back plate has a heating device for preheating the back plate. Thus, when the substrate holding device holding the substrates is immersed in the heated treating solution, the temperature fall of the treating solution under the thermal influence of the back plate is suppressed to check variations in treatment occurring among the substrates.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is an explanatory view illustrating a drawback of the prior art;

FIG. 2 is an explanatory view of a substrate treating method according to this invention;

FIG. 3 is an explanatory view illustrating effects of the substrate treating method according to this invention;

FIG. 4 is another explanatory view illustrating effects of the substrate treating method according to this invention;

FIG. 5 is a plan view showing an outline of a substrate treating apparatus according to this invention;

FIG. 6 is a perspective view of a principal portion of the substrate treating apparatus; and

FIG. 7 is an explanatory view of a modified apparatus.

### DESCRIPTION OF THE PREFERRED EMBODIMENTS

A preferred embodiment of this invention will be described in detail hereinafter with reference to the drawings.

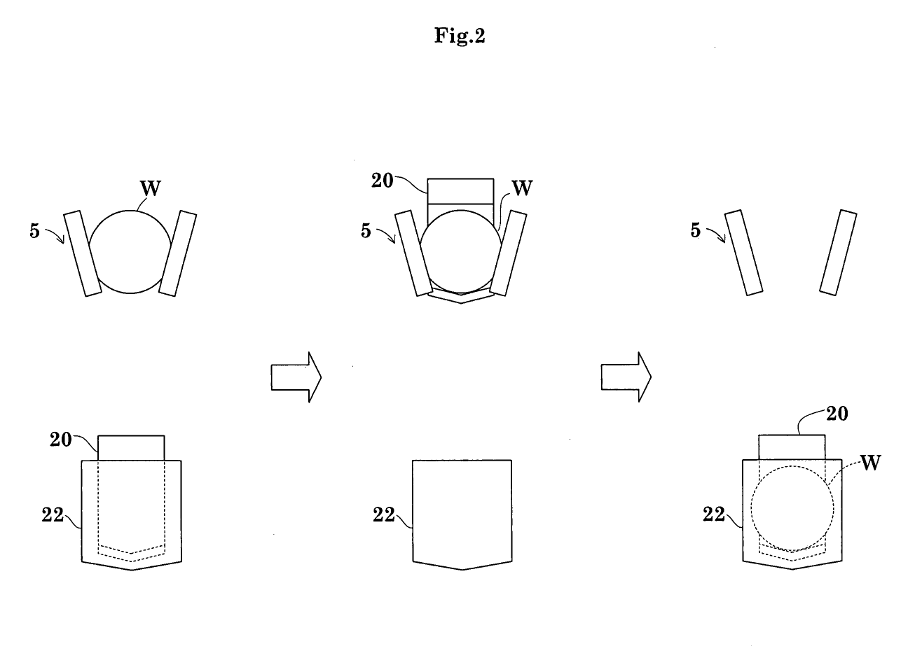

FIG. 2 is an explanatory view of a substrate treating method according to this invention.

This embodiment is directed to etching of silicon nitride film formed on surfaces of wafers W (e.g. semiconductor wafers) by immersing a plurality of wafers W in batches in a heated phosphoric acid solution. However, this invention is not limited to the treatment with a phosphoric acid solution, but is applicable to treatment with any chemical solution (e.g. of sulfuric acid) or pure water as long as the solution is heated. The type of treatment is not limited to etching treatment, either.

In FIG. 2, numeral 5 denotes a substrate transport mechanism for transporting a group of wafers W to be treated together, numeral 20 denotes a lifter for holding the wafers W to be treated together and immersing the wafers W in a heated phosphoric acid solution, and numeral 22 denotes a treating tank storing the heated phosphoric acid solution. The lifter 20 corresponds to the substrate holding device in this invention.

The substrate treating method in this embodiment is characterized in that the lifter 20 is preheated by being immersed in the heated phosphoric acid solution stored in the treating tank 22 before immersing the lifter 20 holding a plurality of wafers W in the heated phosphoric acid solution (see the left end portion of FIG. 2). When a group of wafers W is transported by the substrate transport mechanism 5 to the treating tank 22, the lifter 20 is raised from the treating tank 22 and receives the wafers W from the substrate transport mechanism 5 (see the middle portion of FIG. 2). The lifter 20 having received the wafers W is lowered promptly to immerse the wafers W in the heated phosphoric acid solution in the treating tank 22, whereby the wafers W are collectively subjected to etching treatment (see the right end portion of FIG. 2).

According to the method in this embodiment, as described above, the lifter 20 is immersed in the heated phosphoric acid solution to be preheated to substantially the same temperature as the phosphoric acid solution, before immersing the lifter 20 holding a plurality of wafers W in the heated phosphoric acid solution. Thus, when the wafers W held by this lifter 20 are immersed in the phosphoric acid solution, the temperature of the phosphoric acid solution is prevented from lowering under the influence of the lifter 20. This is effective to suppress variations in treatment occurring among the wafers W treated together.

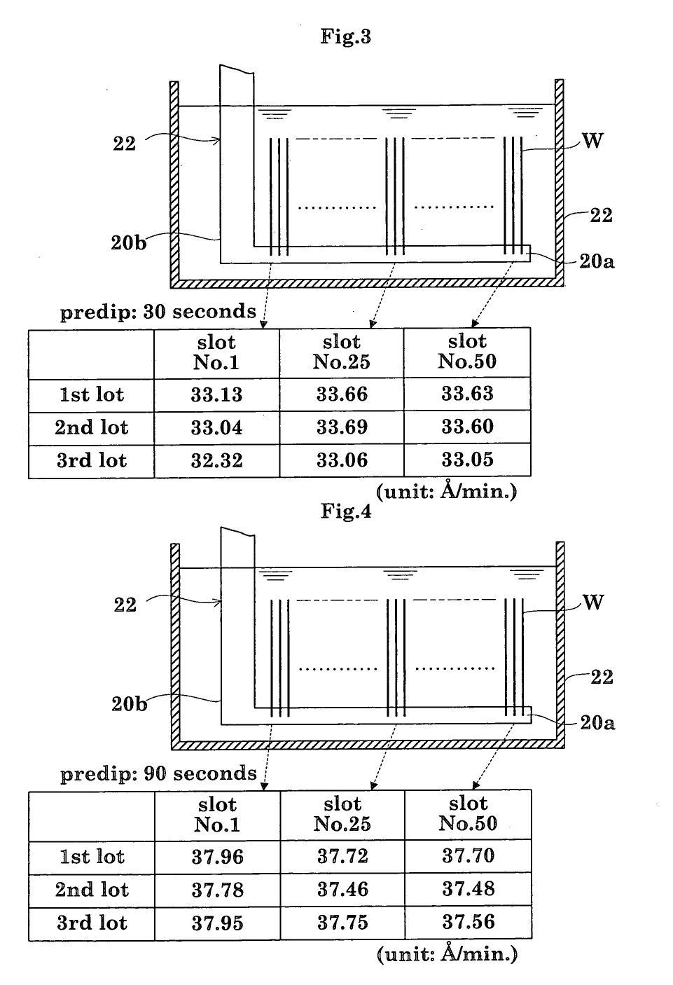

FIG. 3 shows etching rates measured of wafers W (slot No. 1, No. 25 and No. 50) among 50 wafers W treated together as held by the lifter 20 after the lifter 20 alone is immersed (pre-dipped) in the heated phosphoric acid solution (at 150° C.) for 30 seconds. FIG. 4 shows etching rates similarly measured of wafers W after pre-dipping the lifter 20 for 90 seconds.

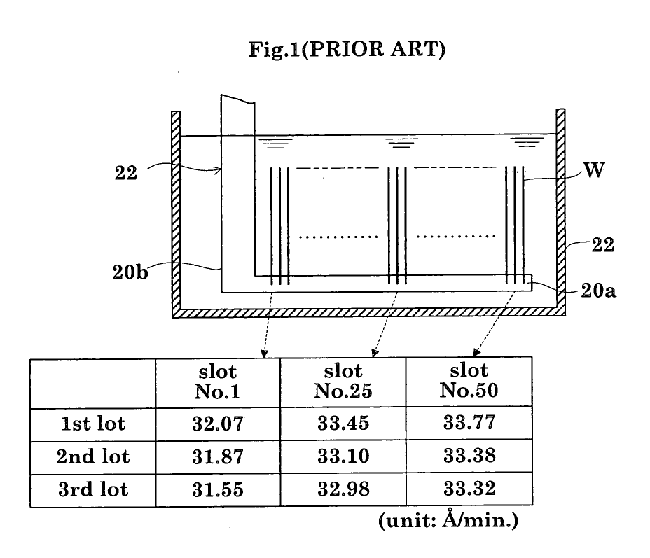

In the case of pre-dipping for 30 seconds shown in FIG. 3, the first lot shows a maximum difference of 0.53 Å/min. in etching rate between the wafers W. The second lot shows a difference of 0.65 Å/min. in etching rate between the wafers W. The third lot shows a difference of 0.74 Å/min. in etching rate between the wafers W. Variations in etching rate between the wafers W are significantly improved over the case shown in FIG. 1 including no pre-dipping step. However, the etching rate is somewhat low in the vicinity of the back plate 20b.

In the case of pre-dipping for 90 seconds shown in FIG. 4, the first lot shows a maximum difference of 0.26 Å/min. in etching rate between the wafers W. The second lot shows a difference of 0.32 Å/min. in etching rate between the wafers W. The third lot shows a difference of 0.39 Å/min. in etching rate between the wafers W. In this example, only very little variations in etching rate occur with the wafers W. Owing to the pre-dipping of the lifter 20, hardly any local temperature fall is considered to take place with the phosphoric acid solution.

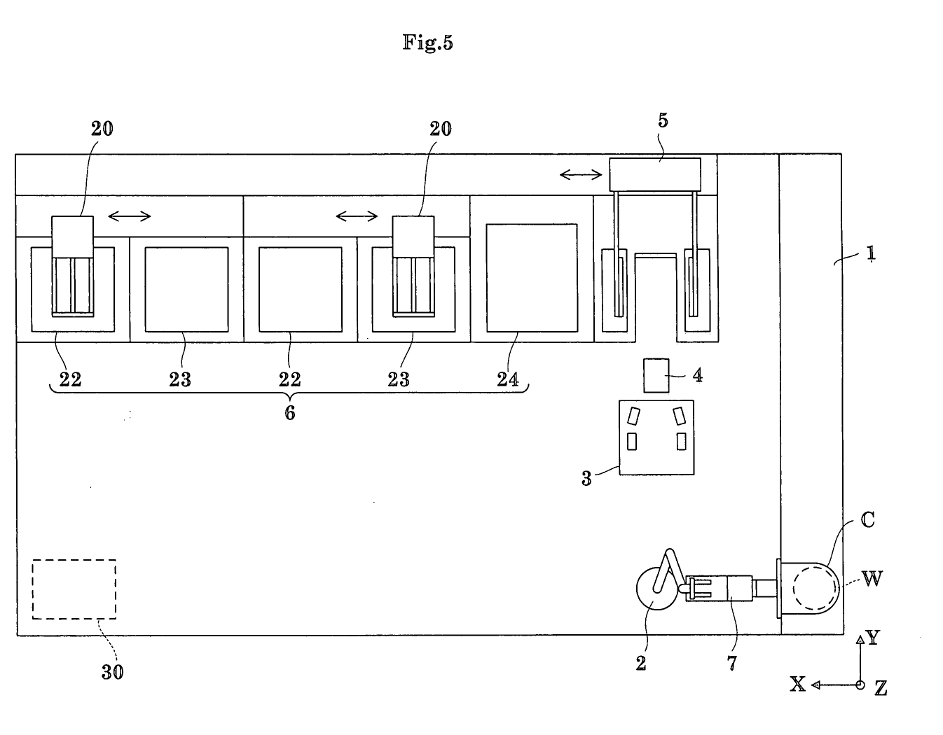

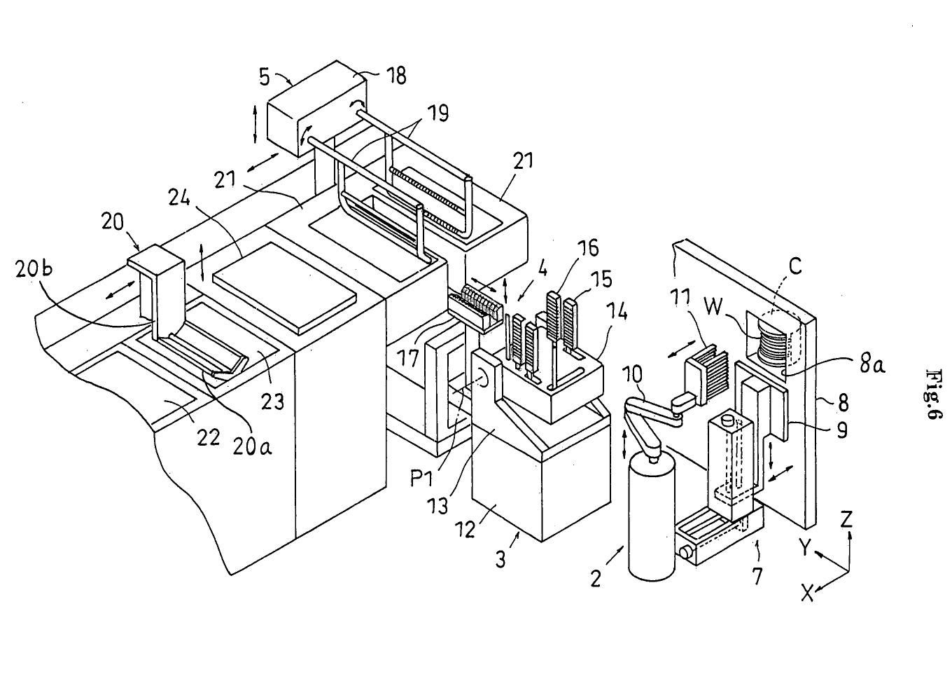

Next, one example of substrate treating apparatus employing the above substrate treating method will be described. FIG. 5 is a plan view showing an outline of a substrate treating apparatus according to this invention. FIG. 6 is a perspective view of a principal portion of the apparatus.

As shown in FIG. 5, the substrate treating apparatus, broadly, includes a container rest 1 for receiving thereon a container C storing wafers W to be treated collectively, a substrate transfer robot 2 for fetching the wafers W to be treated from inside the container C and for loading treated wafers W into the container C, a posture changing mechanism 3 for changing a posture of wafers W all together from horizontal to vertical (upstanding) or vice versa, a pusher 4 for receiving and delivering the wafers W from/to the posture change mechanism 3, a substrate transport mechanism 5 for receiving and delivering the wafers W from/to the pusher 4 and transporting the wafers W, and a treating station 6 for batch-treating the wafers W transported by the substrate transport mechanism 5. Between the container rest 1 and substrate transfer robot 2, a shutter drive mechanism 7 is disposed for opening and closing an opening 8a in a partition 8, as described hereinafter.

Each component of the apparatus will particularly be described hereinafter.

The container C stores a plurality of (e.g. 25) wafers W in horizontal posture. The container C has a lid (not shown) detachably attached to an access opening thereof for sealing the interior of container C from ambient air.

As shown in FIG. 6, the partition 8 acting as an atmospheric barrier is disposed between the container rest 1 and the treating station 6. The partition 8 defines an opening 8a for allowing passage of the wafers W. The container C is placed on the container rest 1 to be opposed to this opening 8a. When the treatment of wafers W is off, the opening 8a is closed by a shutter 9.

The substrate transfer robot 2 includes an articulated arm 10 which is vertically movable, swivelable and movable back and forth. The articulated arm 10 has U-shaped holding arms 11 attached in multiple stages to a distal end thereof for holding wafers W. The substrate transfer robot 2 fetches and deposits the wafers W en bloc from/in the container C by using this holding arm 11. Of course, the substrate transfer robot 2 may fetch and deposit one wafer W at a time.

The posture changing mechanism 3 includes a support block 12, a base 13 mounted on the support block 12, and a swing deck 14 supported on the base 13 to be pivotable about an axis P1. The swing deck 14 has a pair of first holding mechanisms 15 and a pair of second holding mechanisms 16 for supporting the wafers W in multiple stages. By a drive mechanism not shown, the swing deck 14 is switchable between a horizontal posture shown in FIG. 6 and a vertical posture turned 90 degrees therefrom. Consequently, the wafers W supported by the first and second holding mechanisms 15 and 16 may be changed from horizontal posture to vertical posture (or vice versa).

The pusher 4 is disposed adjacent the swing deck 14. The pusher 4 is movable vertically (Z-direction) and horizontally (Y-direction), and includes a holder 17 mounted on top for holding the wafers W in vertical posture. The pusher 4 transfers the wafers W between the posture changing mechanism 3 and substrate transport mechanism 5.

The substrate transport mechanism 5 includes a transport robot 18 movable horizontally (X-direction) along the treating station 6 and vertically, and a pair of pinching mechanisms 19 capable of an open and close motion and extending horizontally from the transport robot 18. The substrate transport mechanism 5 in a standby position shown in FIGS. 5 and 6 receives and delivers the wafers W from/to the pusher 4, and transports the wafers W received to the treating station 6. The substrate transport mechanism 5 also receives and delivers the wafers W from/to lifters 20 provided for the treating station 6. In the standby position of the substrate transport mechanism 5, a pair of rinsing tanks 21 are disposed for rinsing the pair of pinching mechanisms 19. The pusher 4 is movable into a space between the pair of rinsing tanks 21.

The treating station 6 includes two units, each having a treating tank 22 for storing a heated phosphoric acid solution, and a cleaning tank 23 for cleaning wafers W treated with the phosphoric acid solution. The treating station 6 further includes a drying section 24 disposed adjacent the standby position of the substrate transport mechanism 5. Each unit has a lifter 20 movable vertically and horizontally in X-direction for immersing the wafers W received from the substrate transport mechanism 5 all together in the treating tank 22, and immersing treated wafers W together in the cleaning tank 23. The lifter 20 has a plurality of elongate holding rods 20a for holding the group of wafers W in vertical posture to be treated collectively, and a back plate 20b supporting the holding rods 20a in cantilever fashion. Both holding rods 20a and back plate 20b are formed of quartz.

The substrate treating apparatus in this embodiment includes a controller 30 for controlling the substrate transfer robot 2, posture change mechanism 3, pusher 4, substrate transport mechanism 5, lifters 20 and so on.

An operation of the substrate treating apparatus having the above construction for treating a plurality of wafers W collectively will be described.

After a container C containing a plurality of wafers W in horizontal posture is placed on the container rest 1, the shutter drive mechanism 7 opens and lowers the shutter 9 of the partition 8 and the lid of the container C. Once the shutter 9 is opened, the holding arm 11 of the substrate transfer robot 2 advances into the container C and fetches the group of wafers W all together from the container C. The substrate transfer robot 2 transfers the fetched group of wafers W to the posture changing mechanism 3. The swing deck 14 of the posture changing mechanism 3 is in horizontal posture at this time, and the group of wafers W is horizontally supported by the first holding mechanisms 15 and second holding mechanisms 16.

After receiving the group of wafers W, the swing deck 14 of the posture changing mechanism 3 swings 90 degrees toward the pusher 4. As a result, the group of wafers W supported by the first and second holding mechanisms 15 and 16 also are turned 90 degrees to assume an upstanding posture. At this time, the pusher 4 is in a lower position. Then, the pusher 4 is raised to receive the wafers W from the first and second holding mechanisms 15 and 16. This completes a first transfer of the wafers W to the pusher 4.

In this embodiment, a maximum of 50 wafers W may be treated collectively. The container C stores a maximum of 25 wafers W. Thus, after delivering the first group of wafers W, a different container C is placed on the container rest 1. As described above, a group of wafers W is fetched from the container C, transferred to the posture changing mechanism 3 for changing the posture of the wafers W, and transferred to the pusher 4. For transferring a second group of wafers W to the pusher 4, the pusher 4 is raised in a position slightly displaced horizontally (in Y-direction). Thus, the pusher 4 receives the second group of wafers W each in a space between the wafers W in the first group.

The pusher 4 having received a plurality of (a maximum of 50) wafers W as described above moves horizontally toward the space between the pair of rinsing tanks 21. The pusher 4 having moved between the pair of rinsing tanks 21 then moves upward. At this time, the substrate transport mechanism 5 is in the standby position, with the pair of pinching mechanisms 19 in the open state. The pinching mechanisms 19 close after the pusher 4 arrives at a predetermined position above the lower end of the pinching mechanisms 19. Then, the pusher 4 lowers, thereby transferring the group of wafers W from the pusher 4 to the pair of pinching mechanisms 19.

The substrate transport mechanism 5 having received the group of wafers W moves horizontally along the treating station 6. While the group of wafers W is fetched from the container C, transferred to the posture changing mechanism 3 for posture changing, transferred to the pusher 4 and transferred to the substrate transport mechanism 5, the lifter 20 in the treating station 6 not engaged in treatment of wafers W is kept on standby in the heated phosphoric acid solution in the treating tank 22 (see the left end portion of FIG. 2). By standing by in the heated phosphoric acid solution, the lifter 20 is heated to substantially the same temperature as the phosphoric acid solution. When the group of wafers W to be treated collectively is transported by the substrate transport mechanism 5 to the treating station 6, the lifter 20 is raised from the treating tank 22 and receives the wafers W from the substrate transport mechanism 5 (see the middle portion of FIG. 2). The lifter 20 having received the wafers W is lowered promptly into the treating tank 22 to immerse the wafers W in the heated phosphoric acid solution, whereby the wafers W are collectively subjected to etching treatment (see the right end portion of FIG. 2). Such movement of the lifter 20 is controlled by the controller 30.

Upon lapse of a predetermined processing time, the lifter 20 ascends to withdraw the group of wafers W up from the phosphoric acid solution. Then, the lifter 20 moves horizontally to the cleaning tank 23, and the group of wafers W treated with the phosphoric acid solution is immersed in pure water in the cleaning tank 23. After cleaning treatment with the pure water, the lifter 20 ascends to withdraw the group of wafers W up from the cleaning tank 23. The group of wafers W withdrawn upward is transferred from the lifter 20 to the substrate transport mechanism 5 which transports the wafers W to the drying section 24. The lifter 20 now unloaded returns to the treating tank 22 and stands by in the heated phosphoric acid solution. The group of wafers W delivered to and dried in the drying section 24 is transferred to the substrate transport mechanism 5 again. The substrate transport mechanism 5 transports the group of dried wafers W to the standby position.

The group of wafers W transported to the standby position is transferred from the substrate transport mechanism 5 to the pusher 4 in an operation reversed from the incoming time. The group of wafers W received by the pusher 4 is transferred to the posture changing mechanism 3 in two separate groups. The wafers W received by the posture changing mechanism 3 are turned from vertical posture to horizontal posture. The wafers W having undergone the posture change are returned to the containers C by the substrate transfer robot 2. This completes the series of substrate treating steps.

This invention is not limited to the foregoing embodiment, but may be modified as follows:

(1) In the foregoing embodiment, the lifter 20 is preheated by being immersed in the heated phosphoric acid solution before treating a group of wafers W. However, the invention is not limited to this preheating step. The lifter 20 may be preheated before treating a group of wafers W, by being placed in a heated atmosphere or heated liquid (e.g. heated pure water). Alternatively, the lifter 20 may be preheated by a heating device such as a heater provided therefor.

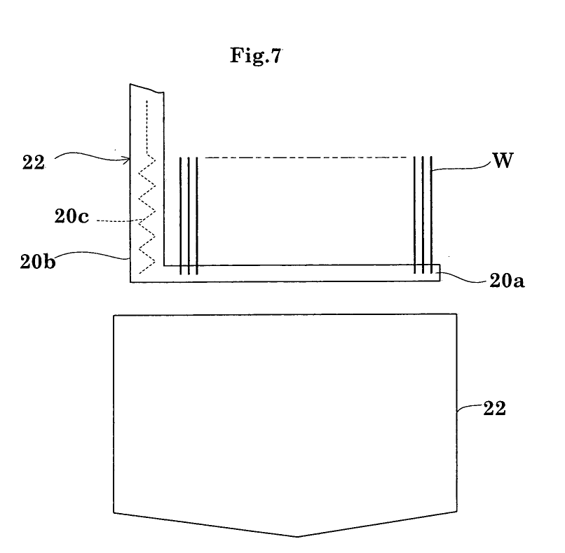

(2) FIG. 7 shows a modification in which a heating device such as a heater provided for the lifter 20 in the apparatus shown in FIGS. 5 and 6. The holding rods 20a of the lifter 20 have a relatively small heat capacity, and therefore have a relatively little thermal influence on the heated phosphoric acid solution. On the other hand, the back plate 20b has a large heat capacity, and has a strong thermal influence on the phosphoric acid solution. Thus, a heater 20c is mounted in or on the back plate 20b of the lifter 20 to preheat the back plate 20b, thereby to suppress the thermal influence on the heated phosphoric acid solution. This measure also is effective to suppress variations in treatment occurring among substrates treated collectively.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating method for performing a predetermined treatment of a plurality of substrates as held by substrate holding device and immersed in a heated treating solution, wherein:
said substrate holding device is heated before immersing said substrate holding device holding said substrates in the heated treating solution.

2. A substrate treating method as defined in claim 1, wherein said substrate holding device is heated by being placed in a heated atmosphere or heated liquid, before immersing said substrate holding device holding said substrates in the heated treating solution.

3. A substrate treating method as defined in claim 2, wherein said substrate holding device is heated by being placed in the heated treating solution without holding said substrates, before immersing said substrate holding device holding said substrates in the heated treating solution.

4. A substrate treating method as defined in claim 2, wherein said heated liquid is heated pure water.

5. A substrate treating method as defined in claim 1, wherein said substrate holding device is heated by heating device provided therefor, before immersing said substrate holding device holding said substrates in the heated treating solution.

6. A substrate treating method as defined in claim 1, wherein said heated treating solution is a phosphoric acid solution.

7. A substrate treating method as defined in claim 1, wherein said heated treating solution is sulfuric acid.

8. A substrate treating method as defined in claim 1, wherein said predetermined treatment of said substrates as immersed in said heated treating solution is etching treatment.

9. A substrate treating apparatus for performing a predetermined treatment of a plurality of substrates as immersed in a heated treating solution, comprising:
a treating tank for storing the heated treating solution;
a substrate transport mechanism for transporting the plurality of substrates;
substrate holding device for holding the substrates received from said substrate transport mechanism and immersing the substrates in the heated the treating solution stored in said treating tank; and
control part for keeping said substrate holding device on standby in the heated treating solution stored in said treating tank, before said substrate holding device receives the substrates from said substrate transport mechanism.

10. A substrate treating apparatus as defined in claim 9, wherein said heated treating solution is a phosphoric acid solution.

11. A substrate treating apparatus as defined in claim 9, wherein said heated treating solution is sulfuric acid.

12. A substrate treating apparatus as defined in claim 9, wherein said predetermined treatment of said substrates as immersed in said heated treating solution is etching treatment.

13. A substrate treating apparatus for performing a predetermined treatment of a plurality of substrates as immersed in a heated treating solution, comprising:
a treating tank for storing the heated treating solution;
a substrate transport mechanism for transporting the plurality of substrates; and
substrate holding device for holding the substrates received from said substrate transport mechanism and immersing the substrates in the heated the treating solution stored in said treating tank;
wherein said substrate holding device includes a plurality of holding rods for holding the plurality of substrates in vertical posture, and a back plate supporting said holding rods in cantilever fashion, said back plate having heating device.

14. A substrate treating apparatus as defined in claim 13, wherein said heated treating solution is a phosphoric acid solution.

15. A substrate treating apparatus as defined in claim 13, wherein said heated treating solution is sulfuric acid.

16. A substrate treating apparatus as defined in claim 13, wherein said predetermined treatment of said substrates as immersed in said heated treating solution is etching treatment.
